(19) United States
(12) Patent Application Publication
(10) Pub. No.: US 2006/0129771 A1
(43) Pub. Date: Jun. 15, 2006

(54) Managing data migration

(75) Inventors: Koustuv Dasgupta, New Delhi (IN); Rohit Jain, New Delhi (IN); Upendra Sharma, New Delhi (IN); Akshat Verma, New Delhi (IN)

Correspondence Address: Frederick W. Gibb, III;McGinn & Gibb, PLLC, Suite 304, 2568-A Riva Road, Annapolis, MD, 21401, US

(73) Assignee: International Business Machines Corporation, Armonk, NY (US)

(21) Appl. No.: 11/011,861

(22) Filed: Dec. 14, 2004

(51) Int. Cl. G06F 12/00

(52) U.S. Cl. 711/162

(57) ABSTRACT

A method for performing a data migration task on an on-line data storage system comprises computing a migration utility, which is a function of the expected time taken to complete the data migration task and generating migration requests for performing the data migration task, where the data migration task is divided into sub-tasks and a migration request is generated for each sub-task. Next determining a migration deadline for performing the data migration; assigning reward values to customer storage requests; assigning reward values to the migration requests. Then scheduling the migration requests and the customer storage requests to maximize total rewards earned and executing the schedule in order to perform the data migration task

### FIELD OF THE INVENTION

The present invention relates to methods, apparatus and computer programs for managing data migration for a data store. The migration is managed to satisfy competing requirements for migration utility and data access performance, or other business objectives, and has applications for data storage service providers.

### BACKGROUND

The cost of managing storage systems has gone up drastically in recent years due to the evolving complexity of these systems to cope with an increase in the rate of data growth, and demands on performance and availability of these systems. As a result, there is a growing trend towards consolidation of storage resources into single large-scale systems for better resource utilization and reduction in the need for skilled storage system administrators. This is evident in enterprises, where departmental computing and storage resources are often no longer segregated but pooled together in a data center that serves the requirements of all departments. This trend is also manifested in the outsourcing of storage requirements by small and medium scale enterprises to managed storage service providers (SSPs). In an SSP infrastructure, resources are shared among the applications/customers with different QoS (Quality of Service) requirements along with the concomitant revenues. Quite naturally, the best effort service model is inadequate in this scenario. Instead, elaborate Service Level Agreements (SLA) specifying QoS guarantees along with the revenue provisions for meeting, exceeding, or failing those guarantees are signed between the provider and customers.

In today's e-business environment, these systems are always expected to be online and provide access to data at guaranteed QoS levels. At the same time the systems must evolve continuously to handle various factors like increase in the amount of data due to existing and new customers, seasonal variations in workloads, need to replace system components to handle failures, and keep pace with technological changes. This often requires re-organization of data accompanied by reconfiguration of underlying storage hardware, more commonly referred to as data migration. Migration involves two distinct parts: formulating a migration plan that details the data to be moved along with the source(s) and destination(s) for the data, and executing the migration plan by moving the data to the specified destination(s). Hitherto, migration has always been considered a low-priority activity and carried out during nights and weekends when client activity is low. However, in today's always-on e-business scenario, there are hardly any inactive periods like these. Moreover, in many situations postponing a migration task to a later time could result in significant revenue loss to the provider. Consider for example, one or more disks in a disk array are showing signs of failure in near future. In this case, data must be migrated from this disk array well before the probability of an actual failure becomes too high. Thus, there is almost a hard deadline for completing migration in this case. In another scenario, an SSF could have promised additional capacity or improved QoS guarantees to a customer in a given time frame. This could involve Storage Area Network (SAN) reconfiguration leading to data migration, which must be completed in the promised time frame to avoid incurring penalties.

Hierarchical Storage Management(HSM) is used in some systems to move less-frequently used data from expensive but high performance SCSI disks to cheap but low performance IDE disks enabling better resource utilization. Recently, there has also been a lot of work on Policy Based Storage Management (PBSM) in which system management is driven by business policies. An important goal of these systems is to ensure the right data is in the right place at the right time. This often necessitates moving data around on volumes providing different QoS guarantees at various times.

Generally speaking, migration always leads to a system configuration that has a greater business value for the provider than the initial configuration. Thus, it is important to execute the migration plan in a fashion that takes into account the overall business utility of migration in addition to the raw performance impact of it.

The most prevalent approach for data migration today is to carry it out as a maintenance activity over nights and weekends when client activity is low. As mentioned before, this approach is clearly infeasible in today's e-business environments that are expected to be in operation 24 hours a day, seven days a week. While existing storage management tools like Veritas Volume Manager and HP-UX Logical Volume Manager continue to provide access to data during the migration process, they do not provide any facility for managing the performance impact of migration on client QoS goals. Veritas Volume Manager does provide a parameter vol_default_iodelay for throttling the rate of data migration, but it is non-adaptive and does not take into account migration deadlines.

The publication “Aqueduct: Online Data Migration with Performance Guarantees” by C. Lu et. al. in Proc. Of USENIX Conference on File and Storage Technologies, 2002, 219-230, (herein after called Aqueduct) describes a control-theoretical approach to guarantee statistical bounds on the impact of a migration plan execution on client performance. The Aqueduct method continuously monitors the client workloads and adapts the migration workload to consume only those resources left unused. While this approach performs much better than non-adaptive methods as far as the impact on client performance is concerned, it always considers migration as a low-priority task that is executed in a best-effort manner with no guaranteed deadline. In heavily loaded systems this could lead to unpredictably long migration duration. Often, data migration is required precisely under these circumstances to modify the system configuration to alleviate the overload.

Recently, the profit maximization of service providers has been addressed by several researchers. Most of these address allocation of resources for various request classes with QoS guarantees so that resources are optimally utilized, thereby maximizing the profit of the providers. One such technique has been described in the publication “Admission Control for Profit Maximimization of Networked Service Providers” by A. Verma et. al. in Proc. International World Wide Web conference, pp 128-137, 2003 (herein after called Verma et. al.). Verma et al addresses the problem of admission control for profit maximization of networked service providers. However, the method of Verma et. al. does not provide any facility for managing the performance impact of migration on client QoS goals.

### SUMMARY

One aspect of the present invention provides a method of managing data migration for an on-line data storage system. The method includes the steps of generating a schedule comprising data migration requests for performing sub-tasks of the data migration task and customer I/O storage requests for performing customer storage operations, wherein the schedule is generated with reference to migration utility requirements and client performance requirements; and executing the schedule of requests in order to perform the data migration task.

Preferably, the method determines and adapts the rate of data migration in response to received storage access requests and data migration requests, to achieve the migration utility requirements while satisfying other business objectives such as maximizing storage access performance or revenues earnt by a storage service provider from processing storage access operations.

The notion of migration utility is generally a function of the expected time taken to complete the migration. The migration utility requirements may include an explicitly-defined deadline for completion of data migration (e.g. defined in a SLA between a customer and a storage service provider). Alternatively, an effective deadline or a migration utility function may be calculated from the available bandwidth and SLA-defined performance commitments. An example is where performance commitments or SLA-defined rewards and penalties necessitate migration to increase storage access bandwidth and avoid delays, or to preemptively replace a system component which is showing signs of likely failure.

A number of migration utility functions may be implemented. For example, a SLA-related-rewards step function may be appropriate if failure to complete migration within a deadline could lead to a major impact on availability (such as because of a predicted component failure or a scheduled system outage). A different migration utility function is appropriate where the migration is required for ongoing 1/0 performance without a specific completion deadline. In the latter example, a target deadline for migration completion and a migration rate could be determined by applying the objective of maximizing overall performance.

The schedule of operations is preferably generated with reference to a set of operational requirements for an on-line data storage system, which combines a set of migration utility requirements and storage access requirements. The storage access requirements may be defined in terms of performance of processing storage access requests (e.g. throughput or delay minimization), or in terms of business objectives such as maximizing storage service provider (SSP) revenues from processing storage access requests (by reference to SLA-defined rewards and penalties) within the constraints of the migration utility requirements. Thus, enabling adaptation of a rate of migration in response to workload variations, to minimize loss of potential storage access rewards while ensuring that migration completes within a target deadline. The method preferably uses short-term predictions of the arrival of storage access requests to determine a suitable rate of migration. Such predictions are preferably utilised with calculated longer-term averages of request arrival rates.

Preferably, the method assigns a migration utility to a data migration task, relative to the client I/O workloads, that captures the true business value of the migration task. The preferred method includes a mechanism for assigning reward values to individual migration requests, which constitute the migration task, which enables comparison of migration requests with client I/O requests. The method uses a variant of the admission control and scheduling method of Verma et al. to schedule the client I/O and migration requests in an integrated fashion with the goal of maximizing the total reward earned by the system. An important feature of this approach is that it not only adapts the rate of migration to soak up the spare system capacity, but at times of system overload, it might actually give priority to migration requests over client I/O requests in order to maximize the reward earned. This approach has an important benefit that it always results in predictable migration completion deadline given long-term client traffic statistics. These properties make it extremely useful in today's service-oriented environments. Another aspect of the present invention provides a data storage system, which comprises a module for generating a schedule comprising data migration requests for performing sub-tasks of the data migration task and customer I/O storage requests for performing customer storage operations, wherein the schedule is generated with reference to migration utility requirements; and a module for executing the schedule of requests in order to perform the data migration task.

The steps of the methods and components of the systems as described above may be implemented in computer program code, which controls the performance of operations on a data processing apparatus on which the code executes. A computer program may be made available as a program product comprising program code recorded on a recording medium or available for download via a data transfer medium.

### DESCRIPTION OF THE DRAWINGS

A number of preferred embodiments of the present invention will now be described with reference to the drawings, in which:

FIG. 1 illustrates a schematic representation of a Storage Service Provider (SSP) System;

FIG. 2A shows a chart of an example revenue distribution of a SSP system with respect to time for two disk configurations Cᵢ and C_{f};

FIG. 2B shows a chart of an example revenue gain of a SSP system in configuration C_{f} over Cᵢ with respect to time;

FIG. 3 shows a chart of an example capacity distribution of requests with respect to rewards;

FIG. 4 shows a chart of an example non-increasing migration utility function with respect to delay (T);

FIG. 5A shows a chart of an example client I/O input request set;

FIG. 5B shows a chart of the output set of requests generated by the prior art Verma SRJF process; and

FIG. 6 illustrates a flow chart of a method of performing data migration implemented by the SSP system of FIG. 1.

### DETAILED DESCRIPTION

For a better understanding of the embodiments, a brief overview of the Storage Service Provider (SSP) system in accordance with the preferred embodiment is described in Section 1. In Section 2, a more detailed description of the SSP system is outlined. In Section 3, the reward assignment and admission control operations performed by the SSP system are described in more detail. In section 4, some issues regarding implementation of the SSP system in a practical setting are discussed. In section 5, a method for performing data migration is described in detail. Finally, in section 6 a conclusion follows.

1 Overview of SSP System

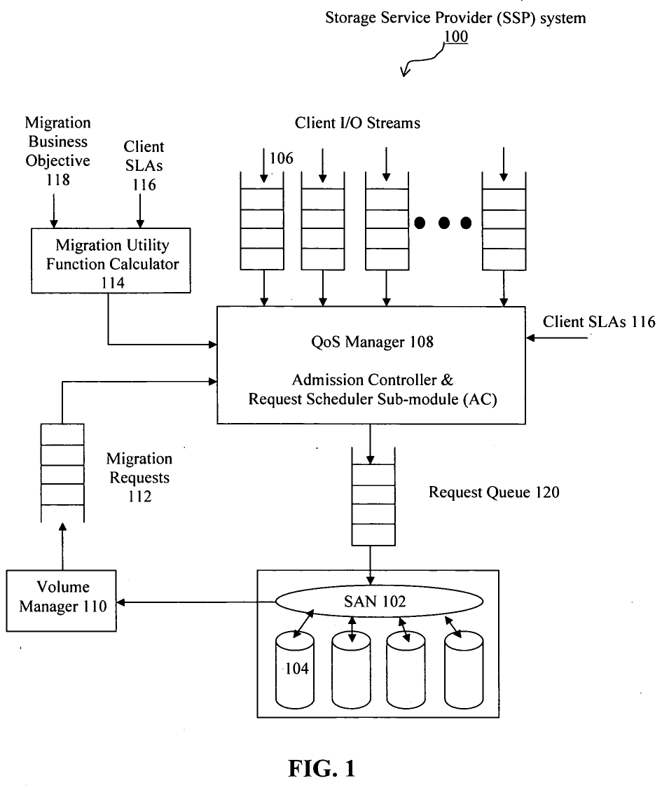

Turning now to FIG. 1, there is shown a schematic representation of the Storage Service Provider (SSP) System 100 in accordance with the preferred embodiment. The SSP system 100 hosts customer data on a large-scale storage area network (SAN) system 102. The storage system 102 consists of a large number of disks organized into disk arrays 104. A disk array 104 is a collection of physical disks that present an abstraction of a single large logical storage device to the rest of the system. This abstraction is referred to herein as a logical unit (LU). These resources are shared by multiple customers/applications with different quality-of-service (QoS) requirements along with concomitant revenues. An application is allocated storage space by concatenating space from one or more logical units (LU); the concatenated storage space is referred to as a logical volume (LV). A request stream 106 refers to an aggregation of I/O requests from a customer, or customer class, and a store as a logical grouping of data accessed by the stream (N.B. The terms customer and client are used interchangeably throughout the description and have the same meaning). The SSP system 100 is adapted to receive multiple such request streams 106.

In the preferred system 100, there typically exists a contract between the operator, viz service provider, of the SSP system 100 and the customer. These contracts usually specify (1) certain QoS guarantees that the provider is expected to meet, and (2) the revenue that is generated by the provider on satisfying these guarantees. The contracts are based on a Service Level Agreement (SLA) between each customer and the service provider that defines these QoS bounds for a class of service, the cost model under which these guarantee will be satisfied, and the anticipated level of per class requests from the customer. The preferred system 100 focuses on providing latency bounds (deadlines) since they are considerably harder to enforce than throughput bounds, and are often the primary criterion for customer applications.

The preferred system 100 is a SLA-driven SSP system, where customer I/O requests are associated with rewards and penalties. In the preferred system 100, rewards are obtained for servicing a request within QoS bounds. Penalties may also be incurred when the request is not serviced at all or serviced outside the QoS bounds. Further, it might be possible (depending on the SLA specifications) to earn extra rewards for servicing additional requests, or exceeding the QoS requirements.

To this end, the SSP system 100 comprises a Quality-of-Service Manager module 108, which receives as input the Client I/O streams 106 and data 116 concerning the QoS requirements contained in the respective clients SLAs. The QoS manager 108, in response to these client I/O requests and migration requests, generates a queue 120 of requests for accessing the Storage Area Network 102. The QoS manager 108 in turn comprises an Admission Controller and a Request Scheduler sub-module (AC) for maximizing the revenue generated by servicing these requests. Preferably, the QoS Manager 106 is in the form of a software code module, which is loaded and executed on a computer that controls the SAN. The operations of this QoS Manager 106 will be described in some detail below.

To ensure service level guarantees, the SSP system 100 has in addition data migration means 110, 112, 114 so the system may adjust to dynamic capacity and/or performance requirements. Indeed, the SSP system 100 is adapted to perform all bulk data migration tasks including backup, archival, and replication. Previous schemes like the Aqueduct method migrate online data using spare bandwidth available after servicing customer requests. In essence, migration is treated as a low-priority best-effort activity with no guaranteed deadline (completion time). However, there are scenarios where a migration plan is associated with a deadline, e.g. one imposed by need to complete recovery inside a mean time between failures. In other cases, like SAN reconfiguration, early migration can improve system performance and minimize the revenue loss arising from SLA violations. The preferred SSP system 100 differs from the Aqueduct method, in that it executes the migration task in such a manner to take into account not only its impact on client applications, but also its overall business utility in terms of meeting these deadlines or generating additional revenue for the provider.

In order to achieve this, the preferred SSP system 100 comprises a migration function calculator 114 for computing a migration utility. The term migration utility as used herein is represented as a function with respect to time t taken to complete the migration. Like in the case of I/O rewards, an effective utility function takes into account the business objectives of the service provider. For example, consider the migration of a store S from a source device (SLV) in configuration Cᵢ to a target device (TLV) in configuration C_{f}. The migration starts at time 0 and finishes at time D. Intuitively, the slope of the migration utility curve at time t, between 0 and D, gives the rate of revenue loss at time I because of the fact that the migration to configuration C_{f} has not finished at time t. The implicit assumption here is that the migration planner has specified the configuration C_{f} so that it yields better business value for the provider than the initial configuration Cᵢ.

It should be noted that the design of a suitable utility function for migration requests (as well as a reward model for I/O requests) is somewhat at the whim of the definer. However, it usually corresponds to the service level agreement and migration constraints specified in terms of the business objectives of the provider. Further, by appropriate changes to the reward (utility) function, one can use the same technique to solve the general problem of maximizing the business objective of the provider.

Returning now to FIG. 1, the preferred SSP system 100 further comprises a volume manager 110, which when a migration task is initiated sends migration I/O requests 112 to the QoS Manager 108. The migration utility function calculator 114 computes the migration utility function based on the clients SLAs 116 and a migration business objective, and passes this function to the QoS Manager 108. The QoS Manager 108 then assigns a reward to each migration I/O request that depends on the rewards of expected client I/O requests, available disk capacity at time t, the number of remaining migration requests at time t and the migration utility. The Admission Controller and Request Scheduler sub-module (AC) then admits and schedules the Client I/O and Migration I/O requests based on these rewards in such a way to maximise the service provider's profits (rewards).

In the remaining part of this section, a number of design reward (utility) functions for customer (migration) requests are elaborated, in a way that can be used in realistic SSP scenarios.

1.1 I/O Reward Model

In the preferred system 100, each customer I/O request rⱼ is represented as r <aⱼ, sⱼ, Fⱼ, Rⱼ(δ)>, where aⱼ is the arrival time of the request, sⱼ is the service time of the request, Γⱼ is the stream with which rⱼ is associated, and Rⱼ(δ) is the reward generated by the request if it is served with a delay of time δ. It should be noted that the reward for an I/O request is represented as a function of the delay faced by the request. Preferably, only those reward functions that are non-increasing with increase in delay are considered. The natural interpretation of the reward Rⱼ(δ) for a customer request rⱼ, that is served within time δ is the revenue that the service provider earns from the customer on serving rⱼ with delay δ.

A general reward function allows the system 100 flexibility to optimize a variety of objective functions, depending on the SLA specifications and the business objectives of the service provider. A provider-centric model would have rewards proportional to service time. Also, rewards can be used to provide differentiated QoS to customers based on the revenue generated by their requests (i.e. SLA class). In a user-centric scenario, the rewards can be formulated in a way that reflects overall customer satisfaction. For example, if the SSP defines user satisfaction as 95% of the requests being served within a latency bound, it can scale up the rewards of the customers who have a large number of I/O requests missing the deadline in the near past. In a scenario where the objective is to minimize the aggregate delay, a reward model that decreases linearly with delay, can be used.

By allowing different I/O requests to have different reward functions, the system 100 can efficiently handle a scenario where different customers (streams) have different SLA constraints and revenue. Notice that, this allows the system 100 to handle mixed-media workloads, where the different kinds of workloads have different utility functions. For example, a linearly decreasing reward function seems to be appropriate for file system workloads. For streaming media workloads, the reward of a request that misses its latency bound (deadline) may be zero. Hence, the appropriate reward function in this case is a step function. In these situations, the admission controller and request scheduler sub-module (AC) of the QoS Manager 108 is able to maximize the revenue where there are different reward functions for different requests. Moreover, the admission controller and request scheduler sub-module (AC) is adapted to reject the “right” subset of requests so that the remaining requests can be serviced within their QoS bounds. Simply stated, the SSP system 100 is able to maximize the revenue generated by taking into account the rewards (and penalties) associated with the individual I/O requests.

1.2 Migration Utility Model

The migration utility Uₘ(t) for a store is represented as a function with respect to time t taken to complete the migration. Like in the case of I/O rewards, an effective utility function takes into account the business objectives of the service provider.

Consider the scenario where a migration request needs to be completed within a certain deadline Tₘₐₓ. In this case, the migration utility of the corresponding store S is defined as follows:

$${U}_{m} ( t ) = \{ \begin{matrix}U & if t \leq {T}_{max} \\ 0 & otherwise\end{matrix} \qquad ( 1 )$$

where U is the revenue gained by the provider on meeting the migration deadline. Stated otherwise, the migration utility can be represented by a simple step-function where the reward of a migration task that misses the stipulated deadline is zero. Many times it is not possible to capture the migration utility directly in terms of reward, but it is still useful to think of it as an indicator of gain in some business objective like worker productivity, better resilience to system failures etc.

In the absence of a deadline, migration of a store can still lead to a better configuration and fetch additional revenue for the service provider (possibly due to fewer SLA violations). In this case, the migration utility can be described as a general function with respect to delay (t). Preferably, only utility functions that are non-increasing with increase in delay are used.

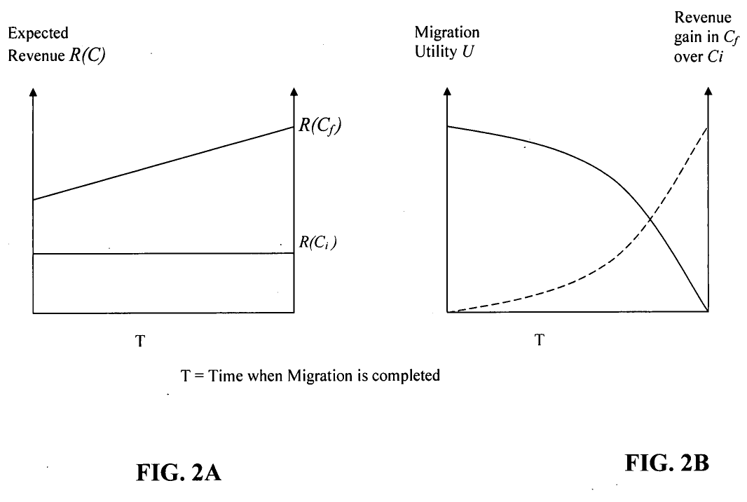

For a clearer understanding of migration utility, reference is made to FIGS. 2A and 2B. FIG. 2A shows a chart of an example revenue distribution of the system 100 with respect to time for two disk configurations Cᵢ and C_{f}. In FIG. 2A, R(Cᵢ) and R(Cⱼ) represent the (expected) revenues generated from servicing customer requests for the two different configurations Cᵢ and C_{f} respectively. As can be seen, the expected revenue over time for configuration C_{f} increases with respect to the expected revenue for configuration Cᵢ and thus in this scenario there is a financial benefit from migrating from configuration Cᵢ to C_{f}. Turning now to FIG. 2B, there is shown a chart of an example revenue gain of the SSP system 100 in configuration C_{f} over Cᵢ with respect to time. As can be seen, the revenue gain of the SSP system is a non-decreasing function of time t shown by the dotted line in FIG. 2B. The corresponding migration utility U is simply an inverse of the revenue gain and hence a non-increasing function of time t (given by the solid line).

2 The SSP System for Performing Data Migration

The SPP system 100 schedules the migration task such that the overall revenue generated by the provider, i.e. the sum of the revenues generated from satisfying the customer requests as well as executing the migration task is maximised. For these purposes, the migration task, i.e. a store that needs to be moved from a source SLV to a destination TLV, is considered to have associated therewith a bandwidth (capacity) requirement. Bₘ for the task (i.e. amount of data that needs to be migrated) and a migration utility Uₘ(t). In addition, there is considered to be at the same time an input set of n customer requests along with the rewards (penalties) for satisfying (violating) the SLA constraints associated with these requests. The total disk capacity for data transfer is denoted as C. In the situation where there is no set deadline for the migration, the SPP system 100 maximises the total revenue by finding the completion time Tₘ for migration in accordance with the following formulae

$${max}_{{T}_{m}} [ {\sum }_{i = 1}^{n} {R}_{i} ( {δ}_{i} ) + {U}_{m} ( {T}_{m} ) ] \qquad ( 2 )$$

where δᵢ is the time taken to complete the i-th customer request, and the total capacity used by migration and I/O requests is no more than available disk capacity C.

In the situation where the migration task has a set deadline Tₘₐₓ, the SPP system maximises the total revenue by solving the following optimization problem,

$${max}_{{T}_{m} \leq {T}_{max}} [ {\sum }_{i = 1}^{n} {R}_{i} ( {δ}_{i} ) + {U}_{m} ( {T}_{m} ) ] \qquad ( 3 )$$

2.1 Scheduling-Based Approach for Online Migration

The SSP system 100 schedules the migration task in the following manner. Firstly, the volume manager 110 of the SSP system 100 divides the store S that needs to be migrated into small, fixed-size sub stores that can be migrated one at a time, in steps called sub tasks. It is envisioned that with advances in hard disk technology (namely, reduced overheads imposed by LVM silvering operations), the size of the sub stores can be made relatively small allowing fine gain control over the migration rate. For simplicity, each migration subtask is referred to as a migration request.

An important part of the SSP system 100 is the admission controller and request scheduler sub-module (AC) of the QoS Manager 108. The admission controller and request scheduler sub-module (AC) uses expected distributions of arrival (and service) times for scheduling future I/O requests. The QoS manager 108 assigns a migration request a reward Rₘ(t), that depends on the expected long term reward distribution for I/O requests, the available disk capacity at time t, the number of remaining migration requests at time t and the migration utility. Next, the admission controller and request scheduler sub-module (AC) uses a variant of the Verma et. al. online admission control process to maximize the revenue of the SSP system 100 generated from servicing the I/O and migration requests.

When a migration is initiated, the volume manager 110 sends the migration I/O requests to the QoS Manager. The Migration Utility Function Calculator 114 calculates the migration utility function based on the client SLAs 116 and system administrator input 118. Based on the client SLAs 116 and migration utility function, the QoS Manager 108 admits and schedules requests in a way that maximizes the service provider's profit. In the following section, there is described how rewards are assigned to migration requests when (1) the migration utility is a step-function as in the case of a deadline, and (2) the migration utility is a general function of time.

3 Reward Assignment for Migration Requests

For ease of explanation of the reward assignments by the QoS manager 108, consider the migration of a store S from one volume to another at time T₀, and let Bₘ be the amount of data that needs to be migrated and C denote the total available disk capacity. Furthermore, the admission controller and request scheduler sub-module (AC) is adapted to implement the following optimal admission control methodology (OAC). At any given time t, the OAC sorts all requests that have not been rejected in order of reward per unit capacity. It then selects as many requests as it can without violating the capacity constraint. Now consider the simple scenario where requests arrive at times T₀+kt, k ε N., where all requests have length equal to t. In such a scenario, the OAC method is also optimal. A general admission control methodology used by the admission controller and request scheduler sub-module (AC) is described in some detail later, but the method and the simple scenario above helps to understand the reward formulation of migration requests.

3.1 Migration With Deadline

The SSP system 100 can operate in one of plurality of modes. In the first mode of the SSP system 100, there is stipulated an expected deadline for migration, e.g. 6 hours. In such a case, it preferable that the service provider incurs no penalty as long as the migration completes in time close to the deadline (e.g. a violation by 5 minutes for a migration task of 6 hours).

The SSP system 100 utilizes, in this first mode, a reward function for migration requests such that the admission controller sub-module selects the requests (I/O and migration) in a manner such that the expected deadline is met and the loss in I/O rewards incurred due to migration is minimized.

For purposes of explanation, let Tₘₐₓ denote the expected deadline for migration. The migration utility function calculator 114 in this first mode utilizes a step function. For instance, the utility of migration is U if it is completed before the deadline, and zero otherwise (step-function). Let Cₘ=Bₘ/(Tₘₐₓ-T₀) denote the average bandwidth required for migration to meet the deadline. Further, let Nₘ be the total number of migration requests that need to be scheduled, and N^{t}ₘ be the number of migration requests remaining at time t.

The potential reward of a migration request is specified as Rₘ such that,

$$λ {\int }_{{R}_{m}}^{∞} {c}_{r} {p}_{r} \leq C - {C}_{m} \qquad ( 4 )$$

where cᵣ is the long term expected capacity used by client I/O requests with reward r, λ is the long term expected number of client I/O requests present at any time given time, and pᵣ is the probability that a client I/O request has reward r.

Equation 4 ensures that the disk capacity available after serving the migration requests is sufficient to service all I/O requests that have rewards higher than the potential reward of the migration requests. The SSP system 100 computes long term forecasts of these values cᵣ, and λ in order to determine the potential reward Rₘ of a migration request.

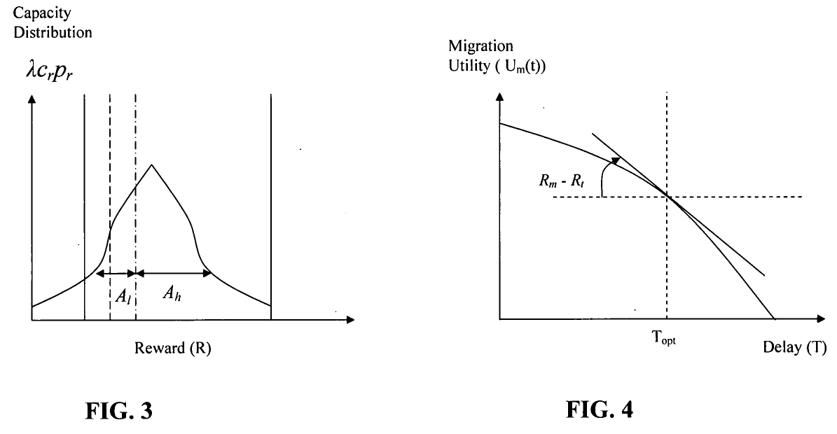

For an explanation of Equation 4, reference is now made to FIG. 3, which shows a chart of an example capacity distribution of requests λcᵣpᵣ with respect to rewards R. The area Aₜ in FIG. 3 denotes the expected capacity taken by the migration requests and the area Aₕ denotes the expected capacity taken by such high reward I/O requests. The latter being equal to the capacity available after serving the migration requests.

In order to ensure that the SSP system 100 serves all migration requests by the deadline, the QoS Manager 108 assigns an actual reward Rₘ(t) for a migration request at time t in accordance with,

$${R}_{m} ( t ) = \{ \begin{matrix}0 & if \frac{U}{{N}_{m}^{t}} < {R}_{m} , \\ {R}_{m} & otherwise\end{matrix} \qquad ( 5 )$$

where Rₘ is the potential reward given by Eqn. 4, and N^{t}ₘ is the number of migration requests remaining at time t.

The case where Rₘ(t) is different from Rₘ refers to a scenario where migration has such a low utility that the deadline can be met only by rejecting I/O requests with higher rewards. In this case, all migration requests are rejected by setting their rewards to 0. In practice, this is not expected to happen since a migration task will be typically be associated with a high enough utility.

With the above reward model for migration and assuming all statistical estimates to be accurate, the optimal admission control (OAC) method used by the admission controller and request scheduler sub-module (AC) serves all requests that are in the region Aₕ (in FIG. 3) along with the migration requests. Expressed in other words, the expected completion time of migration by the OAC method is Tₘₐₓ if the (potential) reward of a migration request is Rₘ. Also, the OAC method services all requests in Aₕ and rejects all requests in Aₜ thereby maximizing the revenue generated by the service provider. The OAC method used by the admission controller and request scheduler sub-module (AC) will be described in some detail below in section 3.3.

3.1.1 Enforcing a Strict Migration Deadline

In another mode of the SSP system 100, the system SSP 100 operates to enforce a strict deadline for migration. In this mode, the utility of migration is U if and only if the task is completed within time Tₘₐₓ.

In this case, the SSP system 100 extends the reward associated with migration requests in a manner such that the deadline is never violated. For instance, consider the situation where the rejection of a migration request at time would lead to missing the deadline (even if migration is given all the disk bandwidth from t onwards). Then, the reward function is replaced by,

$${R}_{m} ( t ) = \frac{U}{{N}_{m}^{t}} \qquad ( 6 )$$

For all other times, the QoS Manager 108 uses Equation. 5 to assign the reward of a migration request.

3.2 Migration with General Utility Functions

As discussed in section 1, there are scenarios where migration utility can be represented as a general function with respect to delay t. In such a scenario, even the time to complete the migration (i.e. deadline) is not explicit.

In this case, the SSP system 100 operates in a further mode. Namely, the QoS Manager 108 first calculates an optimal target deadline for migration to be completed, and then assigns rewards to migration requests, such that the total revenue (rewards) generated by servicing I/O and migration requests is maximized.

The idea behind this mode is based on an extension of the strict deadline mode described above. Namely, the space is partitioned into high and low reward (per unit capacity) requests. We present a provably optimal target deadline without solving the optimization problem rigorously (with potentially non-convex constraints). Specifically, the QoS Manager 108 computes the target deadline T for migration to complete in accordance with the following:

$$\begin{matrix}\frac{{B}_{m}}{{T}_{opt}} & ( 7 ) \\ {\vert \frac{δ {U}_{m} ( t )}{δ T} \vert}_{{T}_{opt}} = {C}_{m} ( {R}_{m} - {R}_{l} ) , & ( 8 )\end{matrix}$$

where Rₜ denotes the long term average reward of requests that have reward less than Rₘ. In other words, Rₜ denotes the long term average reward of requests in the region Aₗ (FIG. 3).

Turning now to FIG. 4, there is shown a chart illustrating an example of a non-increasing migration utility function with respect to delay T. As can been seen, the optimal target deadline Tₒₚₜ is identified at that time, where the slope of the migration utility Uₘ(t) equals the reward Rₘ minus the average reward of requests that have a reward less than Rₘ

Expressed in other words, if Uₘ(t) is a convex function with respect to delay, Tₒₚₜ is the target deadline that maximizes the total expected revenue (sum of I/O rewards and migration utility) for the OAC method. The OAC method used by the admission controller and request scheduler sub-module (AC) will be described in some detail below in section 3.3, but firstly we provide an intuitive proof that explains this basic idea.

Assuming that there is a schedule T with deadline T′ that has total utility larger than any schedule with deadline Tₒₚₜ.

If T′>Tₒₚₜ, then T serves more I/O requests (and fewer migration requests) in time Tₒₚₜ. However, such requests are expected to have reward per unit capacity less than Rₘ. On the other hand, the loss in migration utility by extending migration deadline by unit time is larger than Rₘ-Rₗ (due to convexity of Uₘ(t)). Moreover, extending migration leads to rejection of some I/O requests after time Tₒₚₜ. The loss in I/O reward per unit time due to this migration equals Rₗ. Also, note that if we serve k migration requests in any time, the expected I/O reward loss is larger than kRₘ. Hence, the expected increase in total utility by serving an extra I/O request in time Tₒₚₜ is less than the loss in utility by either delaying migration by 1 time unit any time after Tₒₚₜ or serving an extra migration request by rejecting more I/O requests.

Similarly, if T′<T_{opt,.} it is easy to see that some I/O requests rejected by T have expected reward greater than or equal to Rₘ. Hence, serving one of such requests by delaying migration leads to a loss in migration utility less than Rₘ-Rₗ (due to Convexity of Uₘ). Moreover, the expected I/O reward loss due to such migration after Tₒₚₜ is Rₗ. Hence, again the expected I/O reward loss by completing migration earlier than Tₒₚₜ is more than the sum of the increase in migration utility and expected additional I/O rewards gained.

Once the target deadline is identified, the rest of the procedure is the same as the case with deadline. Namely, the average bandwidth Cₘ required for migration is set to Bₘ/Tₒₚₜ and then the non-strict deadline equations 4 and 5 are used to compute the migration reward Rₘ, i.e., Tₘₐₓ is replaced by Tₒₚₜ and the non-strict deadline method described in section 3.1 is used to compute the migration reward. The potential (and actual) reward values are assigned for each of the remaining migration requests. In this fashion the system SSP uses the long term average arrival rate of client requests and their associated rewards to determine the optimal deadline for migration, namely the deadline that would optimise the reward obtained from completing migration and servicing the appropriate set of requests. This optimal deadline is then used to compute the average rate of migration and the migration rewards. For a fixed deadline case, the rewards for migration requests is computed using the expected long term reward distribution for requests.

Preferably, the QoS Manager 108 solves Eqns. 4, 7, 8 using bisection. The fact that all curves are piecewise linear allows it to find a solution quickly.

3.3 Admission Control for Profit Maximization

Once the QoS Manager has assigned the rewards to the requests, the admission controller and request scheduler sub-module (AC) performs the following profit maximization process. The admission controller and request scheduler sub-module (AC) takes as input a set of n requests, where each request rᵢ can be represented as R{arrivalTime(aᵢ), serviceTime(sᵢ), reward(Rᵢ), responseTimeBound(bᵢ), capacity(cᵢ), serviceClass(Clᵢ)}. These requests are both I-O as well as migration requests. For the purposes of explanation of the operation of the admission controller and request scheduler sub-module (AC), C is defined as the total capacity of the resource available and Tₜₒₜ as the total time under consideration. In the case of migration with deadline, this is taken to equal the length of migration or migration deadline. However, in practice, the admission controller and request scheduler sub-module (AC) would be used even if no migration is in progress and Tₜₒₜ would be some suitably defined long interval.

The admission controller and request scheduler sub-module (AC) is adapted to find a schedule (x_{i,t}) of requests such that the overall revenues are maximized over this period in accordance with the following:

$$MAX {\sum }_{i = 1}^{n} {R}_{i} {\sum }_{t = 1}^{{T}_{tot}} {x}_{i , t} \\ such that \\ \begin{matrix}{\sum }_{i = 1}^{n} {c}_{i} {p}_{i , t} \leq C & ∀ time t ; \\ {\sum }_{t = 1}^{{T}_{tot}} {x}_{i , t} \leq 1 & ∀ request i ;\end{matrix} \\ {x}_{i , t} = \{ \begin{matrix}1 & if {r}_{i} is scheduled at time t \\ and & ( t + {s}_{i} - {a}_{i} ) < {b}_{i} \\ 0 & otherwise\end{matrix} \\ {p}_{i , t} = \{ \begin{matrix}1 & ∀ t : ( t ɛ ( r , r + {s}_{i} - 1 ) \\ and & {x}_{ir} = 1 ) \\ 0 & otherwise\end{matrix} \qquad ( 9 )$$

Where Σₜ₌₁^{T}^{ₜᵢₜ}x_{i,t}=0 implies that the request is rejected. It will be appreciated that this problem can be modeled as bandwidth allocation problem, which is known to be NP-Hard even in a generalized off-line setting. Moreover, the problem needs to be solved in an online setting where the decision of rejecting a request is made without knowledge of the requests, which are scheduled to arrive later.
3.3.1 BSRJF Process

Verma et al describes a probably optimal offline process (SRJf) for profit maximization in the scenario where all requests have the same reward and then extend it for the general case to a process (BSRJF) that is locally optimal. They also provide online versions of the processes. For sake of completeness, these processes are summarised below:

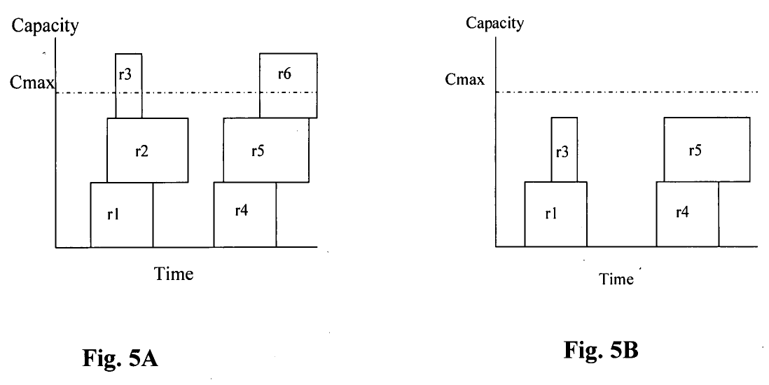

The Verma offline process (SRJF) instead of servicing short jobs first (SJF) uses the shortest remaining time first that combines the idea of selecting a job, which is short and has fewer conflicting requests, and is used in an operating system domain to minimize waiting time. The only difference of SRJF from SJF in this context is that the conflict set is restricted to the set of undecided requests, i.e., the requests which have neither been rejected nor serviced. The input to the Verma SRJF process is a list of requests, which is s0 called an undecided list and the output is a service list and a reject list. The service list being a list of those requests accepted, viz admitted, for scheduling. For example, assume the input request set is as shown in FIG. 5A, and the Verma SRJF process is followed. The Verma SRJF process takes the requests in order, sorted by arrivalTime, i.e. r1, r2, r3, r4, r5, and r6. The Verma SRJF process considers r1 first. It should be noted that the only conflicting request with a shorter remaining time than r1 is r3. Also, even after servicing r3, the Verma SRJF process will have spare capacity left for servicing r1. Hence the Verma SRJF process will accept r1. The Verma SRJF process then considers r2 and rejects it because in the capacity left after serving r1, the Verma process cannot serve both r2 and r3. By the shorter remaining time criterion r3 is selected over r2. Hence, the Verma process rejects r2 and serves r3. In the second set of requests r4 is selected in a similar manner. But between r5 and r6, although r6 is shorter it ends after r5, and so r5 is selected. The output of the SRJF process is shown in FIG. 5B.

To this end, Verma et. al. define their SRJF process as:

Definition 1 Shortest Remaining Job First Process (SRJF): The requests are ordered in order of their arrival. Then a request rᵢ is serviced if there is a capacity left for rᵢ after reserving capacity for all the undecided requests rⱼ, such that aⱼ+sⱼ<aⱼ+sᵢ, Otherwise, rᵢ is rejected.

Verma et. al. also state that once the process takes a request from the undecided list, it is either accepted (admitted) or rejected. It does not go back on the undecided list. The offline Verma et. al. SRJF process described above needs a priori information about a request's arrival and service time. Such information is, however, not available in a real admission control scenario. Also, the requests have a QoS bound on the response time and can be delayed only till the QoS bound is violated.

Hence, short-term prediction of requests' arrival rate and service time distribution is utilized to solve the request maximization problem in a practical online setting.

Since the Shortest Remaining Job First (SRJF) process takes requests sorted on their arrival times, it is easily transformed as an online process. The Verma online SRJF process then works in the following way. When a request arrives, it is checked whether this request can be serviced, given that the expected number of future requests, which are expected to end before it are serviced. To illustrate further, if a request arrives at time I and has a service time of ten, the SRJF process finds the expected number of requests which will arrive at either of (t+1), (t+2,), . . . , (t+9) and end before (t+10), i.e., all those requests which are expected to be serviced before the current request ends. This ensures that the SRJF process maximizes the total number of requests serviced in an expected sense, i.e., if the assumed distribution is an exact set of requests, it should be maximizing the number of requests serviced. Moreover, if the request cannot be serviced immediately, the condition is rechecked after a rejection till such a time that the response time bound may be violated. To illustrate further, if a request with aᵢ=T, sᵢ=10 and bᵢ=20 can not be serviced immediately by the SRJF criteria, it gets re-evaluated till time (T+10), after which it is finally rejected.

The pseudo-code of the Verma SRJF process is presented below.

| | |
|---|---|
| L | =the mean capacity of the requests, |
| Pr(i) | =probability of event i happening, |
| E | =random request with all parameters associated with the respective |

random variables

| | |
|---|---|
| ρ | =discount ratio |

1 Function SRJF schedule
2 for every element j in the available array A[1,...,d]
3 futureRequests[j] = L * Pr( s_{E} <= (d−j))
4 backlog = 0
5 for k =1 to j
6 backlog + futureRequests[k]*Pr(s_{E}>=(j−k))
7 end-for
8 capLeft = available[j] − ρ*(backlog + futureRequests[j])
9 if (capLeft <= 1)
10 return false
11 end-if
12 end-for
13 return true
14 end function

The discount ratio ρ serves two purposes. It captures the confidence in the prediction as well as a future discounting ratio. A predictor with a high error probability would have a ρ much less than 1 as the estimation of futureRequests may be off margin. On the other hand, a sophisticated predictor would have ρ+1. For actual service deployment, the service provider should start with a default value of p depending on the predictor used and converge to the value optimal for her. Note also that in case a request r is rejected by the SRJF schedule once, it is recalled till such a time when the QoS bound on the request r cannot be satisfied, if it is delayed any further.

Also, when a request R₁ (having reward rᵢ and an end time d₁) arrives, a decision horizon is defined as the time between the start and the end of the request R₁. A spare capacity array, called the available array, is computed for the decision horizon, based on the requests that are already scheduled. The available array is indexed against time. Each entry t in the array represents the amount of resource that is available at time t, if no further requests are admitted. The aforementioned SRJF schedule function utilizes this available array in the processing of the current request R₁. Verma et. al also describes the extension of their SRJF process to the general case (BSRJF) where all rewards and penalties are not equal. In this regard Verma et. al make the following definition

Definition 2 Define the conflict set of request rᵢ at time Cᵢ^{t} to be the set of all such requests rj that have not been rejected till time t and either (a) aᵢ+sᵢ>aⱼ and aᵢ+sᵢ<aⱼ+sᵢ or (b) aⱼ+sⱼ>aᵢ and aᵢ+sᵢ>aⱼ+sⱼ.

Also, a high reward conflict set C′ᵢ for a request rᵢ is defined as a subset of Cⱼ^{t} such that all requests in C′ᵢ are non-conflicting with any other request in C′ᵢ. Further, the sum of rewards and penalties of all requests in C′ᵢ is greater than sum of the reward and penalty of request rᵢ.

The Verma et. al. offline BSRJF essentially rejects all such requests rᵢ for which a C′ᵢ exists. It finds out all the candidate C′ᵢ for each rᵢ and pre-reserves capacity for them. If spare capacity is left after pre-reservation, then rᵢ is serviced. This essentially leads to the local optimality condition.

In the online version of their BSRJF, the expected sum of reward and penalties is computed for such C′ᵢ candidates, i.e., the sum of the expected rewards and penalties is computed of non-conflicting request sets rₛ that arrive later. This sum is compared with the reward of the current request under consideration. If the sum of the expected rewards and the penalties saved exceeds the reward of the current request, capacity for rₛ is reserved. This ensures that rᵢ is serviced only if there is no expected C′ᵢ that would be rejected later.

This is incorporated by replacing line 3 of the online SRJF pseudo code with

$$[ j ] = L * {\sum }_{i = 1}^{d - j} ( Pr ( {s}_{E} = i ) * f ( d , i , j ) ) ;$$

where
f(d,i,j)=1, if ∃kεN: Rₘ≦\tilde{R}ₛᵢ+Pr((s_{E}=\tilde{s})≦(d-j-i)/k))*k*(\tilde{R}_{\tilde{s}}+\tilde{P}_{\tilde{s}})
\tilde{R}ₛ=Expected (average) reward for a request with servicetTime s
\tilde{P}ₛ=Expected (average) penalty for a request with serviceTime s

Note that now capacity is not reserved for all earlier ending requests but only those who belong to a such a set C′ⱼ. The Verma BSRJF process in the offline scenario no longer guarantees an optimal solution but a solution that in some sense is locally optimal. This is because there is no single request rᵢ that can be replaced from the solution by some C′ᵢ and the solution would improve. However, there may exist a set of such rᵢ's that could be removed and the solution may increase.

Verma et. al. describe the following example to explain the difference of their BSRJF process from their online SRJF process. If a request rᵢ of length 10 which starts at time-unit 50 and has successfully passed up to 55th time-unit by the process and there is a conflict with a request r_{j,} which spans from 55-58, the BSRJF process may choose rᵢ if the probability of a request of length two (which can fit in 58-60) times the penalty of one request is less than the difference in net reward of rᵢ and rⱼ. More precisely, resource is not reserved for rⱼ in favor of rᵢ if for an expected request k:
Pr(sₖ<=2)(\tilde{R}ₖ+\tilde{P}ₖ)<=Rᵢ+Pᵢ−(Rⱼ+Pⱼ)

Herein, a request of larger length rᵢ is admitted which may disallow an expected shorter request rⱼ later but the probability that there would be another request rₖ in the remaining time is very low, i.e., expected sum of rewards and penalties of C′ᵢ. =rⱼ U rₖ is less than Rᵢ+Pᵢ. One may note that within this formulation online SRJF can be thought of as representing capacity for all such candidate C′_{i.} irrespective of the revenue generated by C′ᵢ.

3.3.2 Migration-Aware BSRJF

The admission controller and request scheduler sub-module (AC) of FIG. 1 implements a variation of the aforementioned BSRJF process. Preferably, the SSP system 100 does not incorporate penalties like BSRJF. However, the concept of penalty can be incorporated in a variation of the SSP system 100 by having rewards equal the sum of the reward and penalty (since rejection of a request leads to loss equal to sum of the reward lost and penalty accrued). It will be appreciated that the BSRJF process pre-reserves capacity for requests with high reward potential before accepting a request for service. This pre-reservation needs information about the requests that are expected to arrive in future. The Verma et. al. process uses a predictor to generate a short term forecast of the requests in order to pre-reserve capacity. The present SSP system 100, preferably estimates a short term forecast of the expected I-O requests using any known time-series based prediction process. However, the migration requests and their rewards are generated deterministically. To take an example, at the onset of migration, the number of migration requests equal the total capacity of the disk. However, as migration requests get serviced, the number of migration requests that arrive at any given time reduce. Moreover, time rewards of such migration requests may change as the deadline approaches. In order to attribute for this fact, the BSRJF process is modified to differentiate between I-O and Migration requests.

Pseudo code for the modified BSRJF process for deciding if a request (migration or I-O) rₘ with reward Rₘ should be serviced is presented below. The lines in bold [9,10] are the ones that differ from the BSRJF process of Verma et. al.

PSEUDO CODE FOR MODIFIED BSRJF PROCESS entitled SCHEDULE

| | |
|---|---|
| L = | request arrival rate |
| | times mean request capacity |
| Pr(i) = | probability of event i happening |
| E = | random request with all parameters |
| | associated with respective random variables |
| p = | future discounting ratio |
| f(d, i, j) = | 1, if ∃k∈N:Rₘ ≧ \tilde{R}ₛᵢ + Pr((s_{E} =\tilde{s}) ≦ (d − j − i)/k))*k*(\tilde{R}_{\tilde{s}}) |
| \tilde{R}ₛ = | Expected (average) reward for a request with servicetTime s |

1 function SCHEDULE
2 for every element j in the available array A [1 . . . d]
$3 futureRequests [ j ] = L * {\sum }_{i = 1}^{d - j} ( Pr ( {s}_{E} = i ) * f ( d , i , j ) )$
4 backlog = 0
5 for k = 1 to j
6 backlog = backlog +
7 futureRequests[k]*Pr(s_{E} ≧ (j − k))
8 end-for
9 futureMigReq = getNumMigReq(j, Rₘ)
10 capLeft = available[j] − futureMigReq − p*
(backlog + futureRequests[j])
11 if(capLeft ≦ 1)
12 return false
13 end-if
14 end-for
15 return true
16 end function

To pre-reserve capacity for migration requests, the modified BSRJF process, at any time Tⱼ, maintains the status of migration (expected number of migration requests completed till time Tⱼ) and determines the number of pending migration requests and their rewards. At any time T, in order to estimate the number of migration requests completed at a later time Tⱼ it assumes that the number of migration requests served between T and Tⱼ equal the average rate of migration needed, i.e. it assumes that at each time Tₖ: T<Tₖ<Tⱼ, the number of migration requests that would get served equals the long term average rate of migration needed. The migration-aware BSRJF algorithm thus computes the futureRequests array for the I-O and migration requests separately. The getNumMigRey sub-process returns the number of such migration requests pending if the migration requests have reward per unit capacity greater than the request under consideration rₘ. If migration request have lower reward, it returns 0 and no capacity is reserved for migration while making the admission control decision for rₘ. For estimating the capacity L used by future I-O requests of any class, it uses a predictor similarly to Verma et. al. The rest of the process runs identical to BSRJF.

It will be appreciated that the for loop needs to be executed for requests of each service class independently since f(d, i, j) would yield different values for requests of different service class. It is not explicitly stated to keep the pseudo code more readable.

4 Implementation Issues

4.1 Prediction Error Adaptation by Slack

The reward functions described earlier are based on the assumption that the reward distribution of I-O requests are known with high degree of accuracy. However, in real systems, this may not always be the case. There are some scenarios where a long term statistical values may be known with high accuracy. However, there may be other scenarios where only an estimate of such values are known (e.g., migration with short deadlines). The SSP system 100 should preferably deal with such errors in prediction.

To this end, a factor of slack(t)^{1-c} is introduced with the migration rewards for the migration scenario with a deadline (viz on the RHS of Eqn 5), where slack is defined as

$$slack ( t ) = \frac{{N}_{M}^{t}}{D - t} \qquad ( 10 )$$

where D=Tₘₐₓ, and N^{t}M is the number of migration requests remaining at time tand c is the confidence ratio. If the long term distribution values are fairly accurate, c→1 and the adaptation factor tends to 1. On the other hand, if the confidence is low, c→0 and the SSP system tries to adapt quickly to the current traffic, thus ensuring that the rate of migration is varied quickly and migration completes close to deadline.
4.2 Recomputing Statistical Values Periodically

The slackfactor allows the SSP system to adapt to errors in prediction and ensures that the migration is not completed too soon or too early because the long term averages were inaccurate. In a real system, such robustness is preferable. However, in the general case, where no deadlines are specified, this simple enhancement may not make the SSP system robust. This is because the process to identify the target deadline depends on the nature of the various curves. Hence, if during a migration, it is found that migration is proceeding at a slower pace than the average rate of migration, the system may not necessarily increase the rate of migration. This is because, the migration duration computed may be less than the optimal migration duration if there were no errors. A simple way to understand all this is that the target deadline is not fixed and depends on the slope of FIG. 4, the area under the curve of FIG. 3 and the associated Eqns. 7, 8.

Hence, if migration shows the tendency of either missing the target deadline or completing too early, it preferable that the SSP system recomputes the target deadline instead of forcing the rate of migration in order to meet the original deadline. Moreover, for very long migration tasks, even such long term averages may change over time and it may be necessary to recompute the migration deadline and rewards. Hence, in actual implementation, the SSP system preferably recomputes the target deadline and migration rewards after suitably chosen intervals in order to make the system adapt to workload changes as well as making it more robust.

5. Preferred Method for Performing Data Migration

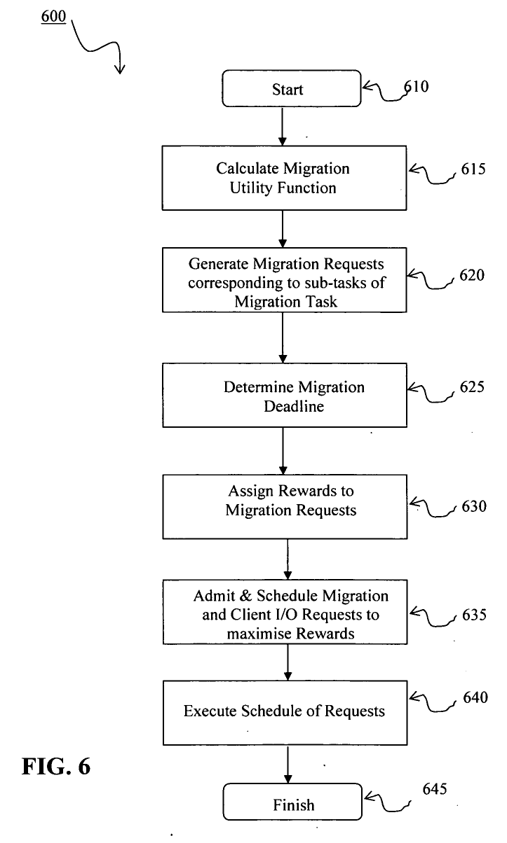

Turning now to FIG. 6, there is shown a flow chart of the method 600 of performing data migration implemented by the SSP system 100. This method 600 is a sub-process of a main method of providing storage service to clients on a SSP system 100, and is implemented 610 once a data migration task is required to be performed on the SSP system 100. After commencement 610 of the method 600, a suitable migration utility function is calculated 615 for the data migration task. Typically, such a migration utility function may take the form of a step function, in the case where the migration task needs to be completed by a certain deadline Tₘₐₓ, or a more general non-increasing function of time, in the case where there is no specific deadline. The migration utility function may be defined manually by a user based on the client service level agreements and migration constraints specified in the terms of the business objectives of the provider. Section 2.2 describes in more detail such migration utility functions.

Once, a migration task is requested, the method 600 generates 620 a series of migration requests corresponding to a series of sub-tasks of the requested migration task. In this way, the migration task can be performed in a series of sub-tasks, where each sub-task corresponds to a sub-store of equal size of the migration store S to be migrated. The volume manager of the SSP system 100 preferably generates these series of migration requests in response to the initial migration task request.

After a series of migration requests have been generated, the method 600 then determines 625 the migration deadline Tₘₐₓ of the corresponding migration task. In the scenario where there is a specific target deadline Tₛ, the migration deadline Tₘₐₓ is set to Tₛ. On the other hand, where there is no specific deadline for completing the migration task, the method 600 calculates the optimal target deadline Tₒₚₜ in accordance with Equations (7) and (8) outlined in Section 3.2 above and sets Tₘₐₓ to Tₒₚₜ.

After the determination of the migration deadline Tₘₐₓ, the method 600 then assigns 630 rewards firstly to the client I/O requests and then the migration requests. These client rewards are computed and assigned to client I/O requests in a manner as described in Section 2.1. As to the migration requests, the reward for a migration request is computed in accordance with equations (4) and (5) of section 3.1, in the situation where the service provider incurs no penalty as long as the migration completes in time close to the deadline Tₘₐₓ. However, where deadline for migration Tₘₐₓ is a strict one, then the rewards are computed in accordance with equations (6) and (5) of sections 3.1.1 and 3.1. In both scenarios, the rewards are assigned to the migration requests based on the expected long term reward distribution for I/O requests, the available disk capacity at time t, the number of remaining migration requests at time t and the migration utility.

After assignment of the rewards to the migration and client I/O requests, then method 600 then admits and generates a schedule 635 of requests to maximise the revenue (rewards). This step 635 is performed by a variant of the Verma et. al. process, which is described in some detail in Section 3.3 above. The method 600 then executes the schedule of requests for performing the data migration and/or the clients storage access operations. After the schedule of requests has been executed 640 the method 600 then terminates 645. In this way, the method 600 divides a migration task into small sub-tasks or migration requests. It uses rewards of the client I/O requests and the migration utility function to assign rewards to such migration requests. The I/O and migration requests are then handled by an admission controller that maximizes the overall rewards earned. This revenue based method computes and assigns an optimal reward for a migration request allowing the method to complete migration before the stipulated time. This method has the advantage in that it adapts well to I/O traffic, in that it decreases the rate of migration during traffic periods of high priority I/O requests and increases the rate of migration latter when such high reward I/O requests are less in number.

Preferably, the aforementioned method 600 implements a slack factor to allow the method 600 to adapt to errors in prediction and to ensure that it does not complete migration too soon or too early because the long term averages were inaccurate. It is further preferable, that the method recomputes the target deadline and migration rewards after suitable chosen intervals in order to make the method 600 adapt to workload changes as well as making it more robust.

6. Conclusion

Various alterations and modifications can be made to the techniques and arrangements described herein, as would be apparent to one skilled in the relevant art.

1. A method of managing a data migration task for an data storage system, wherein the method comprises:
generating a schedule comprising data migration requests for performing sub-tasks of the data migration task and customer (input/output) I/O storage requests for performing customer storage operations, wherein the schedule is generated with reference to migration utility requirements and client performance requirements; and
executing the schedule of requests in order to perform the data migration task.

2. The method of claim 1, wherein the schedule is generated such that the rate of data migration is adapted in response to received customer I/O storage requests and the data migration requests, thereby achieving a balance between the migration and customer I/O storage requests.

3. The method of claim 1, wherein the schedule is generated such that the rate of data migration is adapted in response to received customer I/O storage requests and the data migration requests, thereby achieving the migration utility requirements while maximizing rewards earned by the data storage system.

4. The method of claim 3, further comprising:
assigning reward values to individual customer storage requests; and
assigning reward values to individual migration requests, which constitute the data migration task; and
comparing the rewards of the data migration requests with customer storage requests in order to maximize said rewards.

5. The method of claim 1, wherein the schedule is generated such that the rate of data migration is adapted in response to received customer I/O storage requests and the data migration requests, thereby achieving the migration utility requirements while maximizing customer storage performance.

6. A method of performing a data migration task on an on-line data storage system, wherein the method comprises:
computing a-migration utility which is a function of the time taken to complete the data migration task;
generating migration requests for performing the data migration task, wherein the data migration task is divided into sub-tasks and a migration request is generated for each sub-task;
determining a migration deadline for performing the data migration;
assigning reward values to received customer storage requests, which reward values are representative of revenue generated by performing the customer storage requests;
assigning reward values to the migration requests, which reward values are representative of revenue generated by performing the data migration task and are based on a reward distribution of expected customer storage requests, available storage capacity, number of remaining migration requests, and the migration utility;
scheduling the migration requests and the customer storage requests in such a manner to maximize total rewards earned; and
executing the schedule of requests in order to perform the data migration task.

7. The method of claim 6, wherein the data migration task is stipulated to be completed within a deadline and the determining step sets the migration deadline to the stipulated deadline.

8. The method of claim 7, wherein the migration utility function is a step function of the form:
$${U}_{m} ( t ) = \{ \begin{matrix}U & if t \leq {T}_{max} \\ 0 & otherwise\end{matrix}$$
where U is the rewards earned by meeting the deadline Tₘₐₓ.

9. The method of claim 6, wherein there is no stipulated deadline for completion of the data migration task and the determining step determines the migration deadline as an optimal target deadline that maximizes the total rewards expected to be earned.

10. The method of claim 9, wherein the migration utility function is non-increasing with increase in delay.

11. The method of claim 10, wherein the optimal target deadline Tₒₚₜ is computed in accordance with:
$$\frac{{B}_{m}}{{T}_{opt}} = {C}_{m}$$
$${\vert \frac{δ {U}_{m} ( t )}{δ T} \vert}_{{T}_{opt}} = {R}_{m} - {R}_{l} ,$$
where Rₗ denotes a long term average reward of customer storage requests that have reward less than Rₘ, where Rₘ denotes a potential reward to be assigned to a migration request, Bₘ is a bandwidth required for the data migration task to meet a deadline, Cₘ average bandwidth required for the data migration task to meet the deadline, Uₘ(t) is a migration utility function.

12. The method of claim 8, wherein the step of assigning rewards to migration requests is performed in accordance with:
$${R}_{m} ( t ) = \{ \begin{matrix} 0 & if \frac{U}{{N}_{m}^{t}} < {R}_{m} \\ {R}_{m} & otherwise\end{matrix} ,$$
where Rₘ(t) is the reward assigned to a migration request at time t, Nₘ^{t} is a number of migration requests remaining at time t, Rₘ is a potential reward given by
$$λ {\int }_{{R}_{m}}^{∞} {c}_{r} {p}_{r} \leq C - {C}_{m}$$
where cᵣ is an expected capacity used by customer storage requests with reward r, λ is an expected number of customer storage requests present at any given time, pᵣ is a probability that a customer storage request has reward r, C is total available storage capacity of the data storage system, and Cₘ denotes average bandwidth required for the data migration task to meet the migration deadline.

13. The method of claim 6, wherein the deadline for migration is completed within a predefined deadline and the determining step sets the migration deadline to the predefined deadline.

14. The method of claim 13, wherein the step of assigning rewards to migration requests is performed in accordance with:
$${R}_{m} ( t ) = \frac{U}{{N}_{m}^{t}}$$
where Rₘ(t) is a reward assigned to a migration request at time t, Nₘ^{t} is a number of migration requests remaining at time t, Rₘ is a potential reward given by
$$λ {\int }_{{R}_{m}}^{∞} {c}_{r} {p}_{r} \leq C - {C}_{m}$$
where cᵣ is an expected capacity used by customer storage requests with reward r, λ is an expected number of customer storage requests present at any given time, pᵣ is a probability that a customer storage request has reward r, C is total available storage capacity of the data storage system, Cₘ denotes average bandwidth required for the data migration task to meet the migration deadline, and U is the reward earned by meeting the deadline.

15. The method of claim 6, wherein the reward distribution of expected customer storage requests is based on long term averages of the customer storage requests.

16. The method of claim 15, wherein the method further comprises:
adapting the assigned migration rewards with a confidence factor to correct any errors in prediction of the long term averages.

17. The method of claim 6, wherein the method further comprises:
recomputing the migration deadline and migration rewards after a chosen interval of time.

18. The method of claim 6, wherein the scheduling step further comprises:
admitting those migration requests for scheduling that have reward per unit capacity greater than the customer storage request currently under consideration for scheduling.

19. A method as claimed in claim 6, wherein the method utilizes both long term and short term forecasts of the expected customer storage requests to schedule the migration requests so as to ensure that said migration deadline is met and that the migration is adjusted to cope with bursts in traffic of customer storage requests.

20. A data storage system adapted for managing a data migration task, wherein the system comprises:
means for generating a schedule comprising data migration requests for performing sub-tasks of the data migration task and customer (input/output) I/O storage requests for performing customer storage operations, wherein the schedule is generated with reference to migration utility requirements and client performance requirements; and
means for executing the schedule of requests in order to perform the data migration task.

21. An on-line data storage system for performing customer storage operations and adapted for performing a data migration task, wherein the system comprises:
means for computing a migration utility which is a function of the time taken to complete the data migration task;
means for generating migration requests for performing the data migration task, wherein the data migration task is divided into sub-tasks and a migration request is generated for each sub-task;
means for determining a migration deadline for performing the data migration;
means for assigning reward values to received customer storage requests; which reward values are representative of revenue generated by performing the customer storage requests;
means for assigning reward values to the migration requests, which reward values are representative of revenue generated by performing the data migration task and are based on a reward distribution of expected customer storage requests, available storage capacity, number of remaining migration requests, and the migration utility;
means for scheduling the migration requests and the customer storage requests in such a manner to maximize total rewards earned; and
means for executing the schedule of requests in order to perform the data migration task.

22. A computer program product for managing a data migration task for an data storage system, the computer program product comprising computer software recorded on a computer-readable medium for performing a method comprising:
generating a schedule comprising data migration requests for performing sub-tasks of the data migration task and customer (input/output) I/O storage requests for performing customer storage operations, wherein the schedule is generated with reference to migration utility requirements and client performance requirements.

23. A computer program product for performing a data migration task on an online data storage system, the computer program product comprising computer software recorded on a computer-readable medium for performing a method comprising:
computing a migration utility which is a function of the time taken to complete the data migration task;
generating migration requests for performing the data migration task, wherein the data migration task is divided into sub-tasks and a migration request is generated for each sub-task;
determining a migration deadline for performing the data migration;
assigning reward values to received customer storage requests; which reward values are representative of revenue generated by performing the customer storage requests
assigning reward values to the migration requests, which reward values are representative of revenue generated by performing the data migration task and are based on a reward distribution of expected customer storage requests, available storage capacity, number of remaining migration requests, and the migration utility; and
scheduling the migration requests and the customer storage requests in such a manner to maximize total rewards earned.
